(19) United States
(12) Patent Application Publication
(10) Pub. No.: US 2007/0138956 A1
(43) Pub. Date: Jun. 21, 2007

(54) Electroluminescent display device and method for detecting failure of the same

(76) Inventor: Kwang Sik Lee, Ulsan-si (KR)

Correspondence Address: LEE & MORSE, P.C., 3141 FAIRVIEW PARK DRIVE, SUITE 500, FALLS CHURCH, VA, 22042, US

(21) Appl. No.: 11/642,581

(22) Filed: Dec. 21, 2006

(30) Foreign Application Priority Data
Dec. 21, 2005 (KR) 10-2005-0127229

(51) Int. Cl. H01J 1/62

(52) U.S. Cl. 313/512

(57) ABSTRACT

An electroluminescent display device, including M anode electrodes, N cathode electrodes intersecting the M anode electrodes at right angles, a light emitting layer disposed at each intersection of the M anode electrodes and N cathode electrodes, a testing line positioned at a peripheral position with respect to an outer-most cathode electrode of the N cathode electrodes, wherein the testing line being in communication with the M anode electrodes, and a testing emission layer disposed between the testing line and each of the M anode electrodes. Grounding the testing line and applying inverse voltage to the cathode electrodes facilitates detection of shorts in the display device.

### BACKGROUND OF THE INVENTION

1. Field of the Invention

The present invention relates to electroluminescent (EL) display devices. In particular, the present invention relates to a method for testing an EL device and an EL display device having a structure employable for performing an improved detection method of malfunctioning pixels therein.

2. Description of the Related Art

An electroluminescent (EL) display device is a flat display device where voltage may be applied to light emitting layers interposed between two electrodes to combine electrons and holes to form images. An EL display device may include a substrate, a plurality of anodes, a plurality of cathodes, and at least one light-emitting layer therebetween. EL display devices have superior characteristics as compared to other display devices, such as excellent visibility, light weight, wide viewing angle, high color purity, and relatively low power consumption.

In order to evaluate the functionality of an EL display device, a conventional drive circuit that is similar to a drive circuit employed to operate the EL display device may be manufactured and operated to detect specific line and dot defects within the EL display device. However, such testing may require a long time, since the conventional drive circuit may detect line or dot defects despite of other potential defects in the EL display device. Additionally, when line or dot defects are detected, the entire EL display device may be replaced together with the drive circuit, thereby increasing overall manufacturing costs.

In another exemplary conventional method, DC inverse voltage may be applied to the EL display device to measure occurrence of leakage current in specific points thereof in order to detect defects. In particular, when testing an EL display device having M data lines intersecting with N scan lines, a specific data line may be grounded while current may be applied to a specific scan line to test functionality of a pixel at an intersection of the two lines. For example, testing of a pixel at an intersection of a p-th data line and q-th scan line (1≦p≦M, 1≦q≦N) may involve grounding of the p-th data line and applying current to a q-th scan line to evaluate whether a leakage current occurs at the p×q pixel. However, this conventional testing method may involve a relatively large measuring error due to high resistance at the measuring terminal, thereby reducing the precision and efficiency of the overall testing method.

Accordingly, there remains a need to improve the testing method of the EL display devices in order to provide display devices having enhanced image quality and reliability.

### SUMMARY OF THE INVENTION

The present invention is therefore directed to an electroluminescent (EL) display device and method of testing the same, which substantially overcome one or more of the disadvantages of the related art.

It is therefore a feature of an embodiment of the present invention to provide an EL display device having a testing array incorporated therein.

It is another feature of an embodiment of the present invention to provide a testing method for detecting a failure of an EL display device.

At least one of the above and other features and advantages of the present invention may be realized by providing an EL display device, including M anode electrodes, N cathode electrodes intersecting the M anode electrodes at right angles, a light emitting layer disposed at each intersection of the M anode electrodes and N cathode electrodes, a testing line positioned at a peripheral position with respect to an outer-most cathode electrode of the N cathode electrodes, wherein the testing line being in communication with the M anode electrodes, and a testing emission layer disposed between the testing line and each of the M anode electrodes. Each anode electrode may be connected to a data line and each cathode electrode may be connected to a scan line.

The distance between the testing line and an outermost cathode electrode may be smaller than a distance between any two cathode electrodes. Additionally, a size of the testing emission layer may be smaller than a size of the light emitting layer.

The testing line may be formed in parallel to the N cathode electrodes. Additionally, the light emitting layer may be an organic light emitting layer. Similarly, the testing emission layer may be an organic testing emission layer.

In another aspect of the present invention, there is provided a method for detecting a failure of an electroluminescent display device including a light emitting layer formed at intersections of first M electrode lines and second N electrode lines, a testing line for testing an element formed at outer sides of the second electrode lines parallel with the second electrode lines, and a testing emission layer formed at an intersection of the testing line and a first electrode line extending in a formation direction of the testing line, the method including grounding the testing line for testing the element, applying a direct current voltage to a q (1≦q≦N) line among the second electrode lines opposite to an applied direction of an electric current for driving the electroluminescent display device, and detecting whether a (p×q)-th pixel is shorted by discriminating an emission of a p (1≦p≦M)-th testing pixel. Applying a direct current may include separately applying an electric current to the second electrodes. Additionally, the electroluminescent display device may be an organic light emitting display device.

In yet another aspect of the present invention, there is provided a method for detecting a failure of an EL display device having M anode electrodes, N cathode electrodes, and a light emitting layer disposed at each intersection thereof, N and M being positive integers, the method includes connecting the M anode electrodes to M data lines, connecting the N cathode electrodes to N scan lines, such that the N scan lines intersect the M data lines at right angles, positioning a testing line parallel to the N cathode electrodes and in communication with the M electrodes, such that a testing emission layer is disposed at an intersection of the testing line and each of the M electrodes, grounding the testing, applying an inverse direct current voltage to a q-th (1≦q≦N) line of the N scan lines, and monitoring a light emission from the testing emission layer at a p-th (1≦p≦M) position in the testing line. Applying an inverse direct current voltage to a q-th line may include sequentially applying inverse direct current voltage from a first line to the N line.

Monitoring the light emission from the testing emission layer at the p-th position may include establishing a presence of a short at an intersection of the p-th data line and q-th scan when light is emitted at the p-th position, wherein establishing the presence of a short may include determining a malfunctioning status of the electroluminescent display device.

Alternatively, monitoring the light emission from the testing emission layer at the p-th position may include establishing a lack of a short at an intersection of the p-th data line and q-th scan line when light is not emitted at the p-th position, wherein establishing the lack of a short includes determining an operational status of the electroluminescent display device.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a plan view of an EL display device according to an exemplary embodiment of the present invention; and

FIG. 2 illustrates a general diagram used to describe an exemplary method for detecting a failure of the EL display device illustrated in FIG. 1.

### DETAILED DESCRIPTION OF THE INVENTION

Korean Patent Application No. 10-2005-0127229, filed on Dec. 21, 2005, in the Korean Intellectual Property Office, and entitled, “Organic Light Emitting Display and Method for Detecting Failure of the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements, layers, and regions may be exaggerated for clarity of illustration. It will also be understood that when an element or layer is referred to as being “on” another layer or substrate, it can be directly on the other layer or substrate, or intervening layers may also be present. Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present. Like reference numerals refer to like elements throughout.

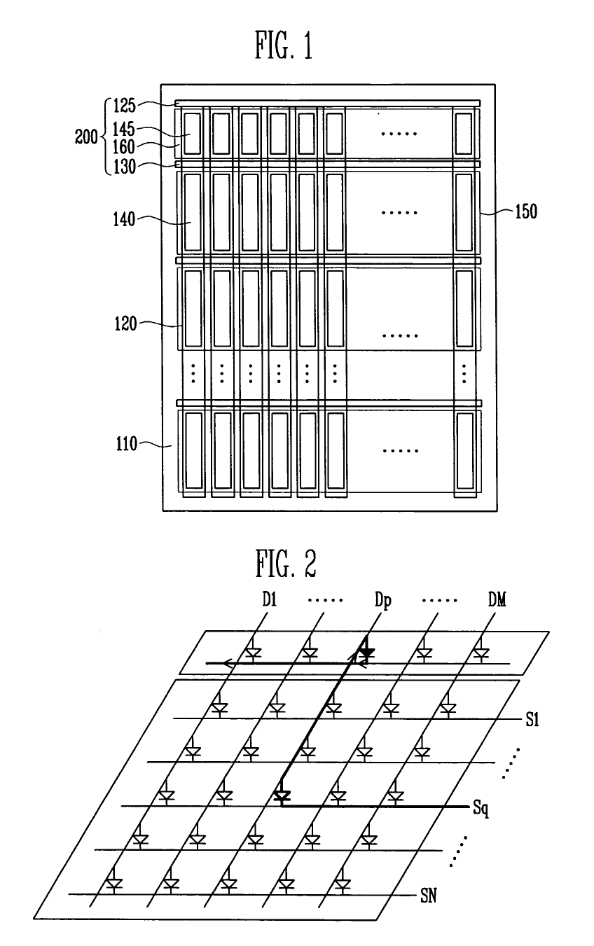

An exemplary embodiment of an electroluminescent (EL) display device according to the present invention is more fully described below with reference to FIG. 1. As illustrated in FIG. 1, an EL display device according to an embodiment of the present invention may include a substrate 110, a plurality of anode electrodes 120, a plurality of cathode electrodes 150, a plurality of light emitting layers 140, a plurality of cathode separators 130, and a testing array 200.

The plurality of anode electrodes 120 may be vertically arranged on the substrate 110 at predetermined intervals, and each anode electrode 120 may be electrically connected to a driver integrated circuit (IC) through a data line. The plurality of anode electrodes 120 may have a length sufficient to position thereon the plurality of cathode electrodes 150, the plurality of cathode separators 130, and the testing array 200. The plurality of anode electrodes 120 may be made of any known material in the art, e.g., indium tin oxide (ITO), indium zinc oxide (IZO), tin oxide (SnO₂), and zinc oxide (ZnO).

The plurality of cathode electrodes 150 may be arranged perpendicularly to the plurality of anode electrodes 120, thereby forming a grid on the substrate 110. Each cathode electrode 150 may be connected to a driver IC through a scan line and may be made of, e.g., lithium, magnesium, aluminum, aluminum-lithium, calcium, magnesium-indium, and magnesium-silver.

Each light emitting layer 140 may be formed between the anode electrode 120 and the cathode electrode 150, such that the light emitting layer 140 may be disposed at an intersection therebetween. The light emitting layer 140 may include an emission layer and additional functional layers, such as an electron injection layer, an electron transport layer, a hole injection layer, and a hole transport layer. The light emitting layer 140 may be formed of any light emitting material known in the art, e.g., phosphorescent material, fluorescent material, and so forth. For example, the light emitting layer 140 may be made of an organic material to form an organic light-emitting layer.

The plurality of cathode separators 130 may be positioned on the substrate 110 parallel to the cathode electrodes 150 to facilitate formation of the plurality of cathode electrodes 150. In particular, each cathode separator 130 may be positioned between two adjacent cathode electrodes 150 and perpendicularly to the plurality of anode electrodes 120.

The testing array 200 may be constructed to facilitate testing of the EL display device, and the testing array 200 may be positioned on the substrate 110 in parallel to the cathode electrodes 150. In particular, the testing array 200 may be positioned at an outer edge of the substrate 110, as illustrated in FIG. 1, such that it may be peripheral to an outer-most cathode electrode 150 and may intersect perpendicularly with the plurality of anode electrodes 120. The testing array 200 may include a testing line 160, a testing emission layer 145, and a testing separator layer 125. The testing array 200 may be in communication with the plurality of anode electrodes 120.

The testing line 160 of the testing array 200 may be an electrode positioned in parallel to the plurality of cathode electrodes 150. For example, the testing line 160 may be positioned at an outermost position on the substrate 110 relative to the plurality of cathode electrodes 150. It should be noted, however, that a distance between the testing line 160 and an outermost cathode electrode 150 may be smaller than a distance between any two cathode electrodes 150. The testing line 160 may be connected to a scan line; however, it may not receive signals from the driver IC.

Additionally, the testing line 160 may have a smaller size as compared to any of the cathode electrodes 150. In particular, e.g., a width, i.e., a distance as measured in a direction parallel to the anode electrodes 120, of the testing line 160 may be smaller as compared to a width of any of the cathode electrodes 150. For example, the plurality of anode electrodes 120 may protrude a predetermined distance beyond the outermost cathode separator 130, such that the testing line 160 may overlap with the protruded anode electrode 120 without making significant changes in the EL display device layout.

The testing emission layer 145 of the testing array 200 may be made of the same material as the light emitting layer 140, and the testing emission layer 145 may be disposed at each intersection of the testing line 160 with each of the plurality of anode electrodes 120. A size of the emission layer 145 disposed at the intersection between the testing line 160 and the anode electrodes 120 may be smaller than a size of any of the light emitting layers 140 disposed at any of the intersections between the anode electrodes 120 and the cathode electrodes 150.

The testing separator layer 125 of the testing array 200 may be formed of the same material as the plurality of cathode separators 130, and it may be positioned parallel thereto. In particular, the testing separator layer 125 may be positioned at an outermost position of the substrate 110 relative to the testing line 160.

When the EL display device according to an embodiment of the present invention is controlled by a passive-type driver, a driver IC may be electrically connected to a source/drain or gate electrode to transfer data signals and scan signals to each anode electrode 120 and cathode electrode 150, respectively.

An exemplary method for detecting malfunctioning of the EL display device according to the invention will be described with respect to FIGS. 1-2. It should be noted, however, that the same elements are included in the embodiment illustrated in FIGS. 1-2. Accordingly, details and descriptions that may be found in both embodiments illustrated in FIGS. 1-2 will not be repeated herein.

In this respect, it should further be noted that the data lines of the anode electrodes 120 and the scan lines of the cathode electrodes 150 may be referred hereinafter as M data lines and N scan lines, respectively. Accordingly, the plurality of intersections therebetween may be referred to hereinafter as M×N pixels, and the testing array 200 may be referred to hereinafter as M×1 pixel array.

As illustrated in FIG. 2, in order to test the malfunctioning of the EL display device, the testing line 160 may be grounded, and a direct current (DC) voltage may be inversely and sequentially applied to each scan line, i.e., q-th scan line, wherein (1≦q≦N). Subsequently, the testing array 200 may be monitored to determine a malfunction. In particular, emission of light from a p-th pixel, i.e., p-th position in the M×1 array, wherein (1<p<M), in the testing array 200 may indicate malfunctioning of a p×q pixel in the EL display device. Lack of emitted light from the testing array 200 may indicate operational status of the EL display device.

Without intending to be bound by theory, it is believed that when DC voltage is applied inversely to a q-th scan line and the EL display device is operational, i.e., the EL device does not include any malfunctioning pixels in its q-th line, no electric current may be transferred and, therefore, no visual indicators, e.g., light, may be observed. Alternatively, when the EL display device is malfunctioning, i.e., the EL device may include points and/or pixels in its q-th line that are shorted, electric current may be transferred through the shorted pixel, e.g., p×q pixel, to the testing line 160 and, thereby, trigger light emission from a p-th position in the testing line 160, i.e. p-th pixel in the testing array 200.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electroluminescent display device, comprising:
M anode electrodes, M being a positive integer;
N cathode electrodes intersecting the M anode electrodes at right angles, N being a positive integer;
a light emitting layer disposed at each intersection of the M anode electrodes and N cathode electrodes;
a testing line positioned at a peripheral position with respect to an outer-most cathode electrode of the N cathode electrodes, the testing line being in communication with the M anode electrodes; and
a testing emission layer disposed between the testing line and each of the M anode electrodes.

2. The electroluminescent display device as claimed in claim 1, wherein each anode electrode is connected to a respective data line and each cathode electrode is connected to a respective scan line.

3. The electroluminescent display device as claimed in claim 2, wherein a distance between the testing line and the outermost cathode electrode is smaller than a distance between any two cathode electrodes.

4. The electroluminescent display device as claimed in claim 2, wherein a size of the testing emission layer is smaller than a size of the light emitting layer.

5. The electroluminescent display device as claimed in claim 1, wherein the testing line is parallel to the N cathode electrodes.

6. The electroluminescent display device as claimed in claim 1, wherein the light emitting layer is an organic light emitting layer.

7. The electroluminescent display device as claimed in claim 1, wherein the testing emission layer is an organic testing emission layer.

8. A method for detecting a failure of an electroluminescent display device including a light emitting layer formed at intersections of first M electrode lines and second N electrode lines, a testing line for testing an element formed at outer sides of the second electrode lines parallel with the second electrode lines, and a testing emission layer formed at an intersection of the testing line and a first electrode line extending in a formation direction of the testing line, the method comprising:
grounding the testing line for testing the element;
applying a direct current voltage to a q (1≦q≦N) line among the second electrode lines opposite to an applied direction of an electric current for driving the electroluminescent display device; and
detecting whether a (p×q)-th pixel is shorted by discriminating an emission of a p (1≦p≦M)-th testing pixel.

9. The method as claimed in claim 8, wherein applying a direct current comprises separately applying an electric current to the second electrodes.

10. The method as claimed in claim 8, wherein the electroluminescent display device is an organic light emitting display device.

11. A method for detecting a failure of an electroluminescent display device having M anode electrodes, N cathode electrodes, and a light emitting layer disposed at each intersection thereof, N and M being positive integers, the method comprising the steps of:
connecting the M anode electrodes to M data lines;
connecting the N cathode electrodes to N scan lines, such that the N scan lines intersect the M data lines at right angles;
positioning a testing line parallel to the N cathode electrodes and in communication with the M electrodes, such that a testing emission layer is disposed at an intersection of the testing line and each of the M electrodes;
grounding the testing line;
applying an inverse direct current voltage to a q-th (1≦q≦N) line of the N scan lines; and
monitoring a light emission from the testing emission layer at a p-th (1≦p≦M) position in the testing line.

12. The method as claimed in claim 11, wherein monitoring the light emission from the testing emission layer at the p-th position includes establishing a presence of a short at an intersection of the p-th data line and q-th scan line when light is emitted at the p-th position.

13. The method as claimed in claim 12, wherein establishing the presence of a short includes determining a malfunctioning status of the electroluminescent display device.

14. The method as claimed in claim 11, wherein monitoring the light emission from the testing emission layer at the p-th position includes establishing a lack of a short at an intersection of the p-th data line and q-th scan line when light is not emitted at the p-th position.

15. The method as claimed in claim 14, wherein establishing the lack of a short includes determining an operational status of the electroluminescent display device.

16. The method as claimed in claim 11, wherein applying an inverse direct current voltage to a q-th line includes sequentially applying inverse direct current voltage from a first line to the N line.
